(19) United States
(12) Patent Application Publication
(10) Pub. No.: US 2025/0078291 A1
(43) Pub. Date: Mar. 6, 2025

(54) Meta-Optic Accelerators for Machine Vision and Related Methods

(71) Applicant: VANDERBILT UNIVERSITY, Nashville, TN (US)

(72) Inventors: Jason G. VALENTINE, Nashville, TN (US); Hanyu ZHENG, Nashville, TN (US); Quan LIU, Nashville, TN (US); Yuankai HUO, Nashville, TN (US)

(21) Appl. No.: 18/652,249

(22) Filed: May 1, 2024

Related U.S. Application Data
(60) Provisional application No. 63/499,302, filed on May 1, 2023.

(51) Int. Cl. G06T 7/33; G02B 5/32; G06F 18/21; G06N 3/0464; H04B 10/532; H04J 14/06

(52) U.S. Cl. CPC G06T 7/33; G02B 5/32; G06F 18/21; G06N 3/0464; H04B 10/532; H04J 14/06; G06T 2207/20084

(57) ABSTRACT

A machine vision system may include a meta-imager including a meta-optic and a polarization-sensitive photodetector. A machine vision system may further include and at least one processor operably coupled to the polarization-sensitive photodetector, and at least one memory operably coupled to the at least one processor. A machine vision system may be configured to: receive, from the polarization-sensitive photodetector, a plurality of feature maps; input, into a trained artificial neural network, the plurality of feature maps; and process, using the trained artificial neural network, the plurality of feature maps to recognize an object.

### CROSS-REFERENCE TO RELATED APPLICATIONS

This application claims the benefit of U.S. provisional patent application No. 63/499,302, filed on May 1, 2023, and titled “META-OPTIC ACCELERATORS FOR MACHINE VISION,” the disclosure of which is expressly incorporated herein by reference in its entirety.

### STATEMENT REGARDING FEDERALLY FUNDED RESEARCH

This invention was made with government support under grant number N00014-21-12468 awarded by the Office of Naval Research. The government has certain rights in the invention.

### BACKGROUND

The rapid development of digital neural networks and the availability of large training datasets have enabled a wide range of machine-learning-based applications, including image analysis^{1,2}, speech recognition^{3,4}, and machine vision⁵. However, enhanced performance is typically associated with a rise in model complexity, leading to larger compute requirements⁶. The escalating use and complexity of neural networks have resulted in increases in energy consumption while limiting real-time decision-making when large computational resources are not readily accessible. These issues are especially critical to the performance of machine vision^{7,8,9} in autonomous systems where the imager and processor must have small size, weight, and power consumption for on-board processing while still maintaining low latency, high accuracy, and highly robust operation. These opposing requirements necessitate the development of new hardware and software solutions as the demands on machine vision systems continue to grow.

### SUMMARY

In some aspects, the techniques described herein relate to a machine vision system including: a meta-imager including: a meta-optic, and a polarization-sensitive photodetector; at least one processor operably coupled to the polarization-sensitive photodetector; and at least one memory operably coupled to the at least one processor, the at least one memory having computer-executable instructions stored thereon that, when executed by the at least one processor, cause the at least one processor to: receive, from the polarization-sensitive photodetector, a plurality of feature maps; input, into a trained artificial neural network, the plurality of feature maps; and process, using the trained artificial neural network, the plurality of feature maps to recognize an object.

In some aspects, the meta-optic is configured to optically implement at least one convolutional layer for the machine vision system.

In some aspects, the meta-optic includes a first metasurface configured for angular multiplexing and polarization multiplexing.

In some aspects, the meta-optic includes a second metasurface configured for configured for focusing.

In some aspects, a point spread function of the meta-optic includes a plurality of focal spots, wherein the meta-optic is configured to encode each of the plurality of focal spots with a respective kernel weight.

In some aspects, the plurality of focal spots include an N×N focal spot array.

In some aspects, a positively valued kernel weight is achieved by encoding a first focal spot with a first polarization state, and a negatively valued kernel weight is achieved by encoding a second focal spot with a second polarization state, wherein the first and second polarization states are orthogonal polarization states.

In some aspects, the first polarization state is one of right-hand-circular polarization (RCP) or left-hand-circular polarization (LCP), and the second polarization state is the other of RCP or LCP.

In some aspects, the first polarization state is one of vertical linear polarization or horizontal linear polarization, and the second polarization state is the other of vertical linear polarization or horizontal linear polarization.

In some aspects, the meta-imager further includes a single aperture through which incoherent light enters the meta-imager.

In some aspects, the step of processing, using the trained artificial neural network, the plurality of feature maps to recognize the object includes detecting the object.

In some aspects, the step of processing, using the trained artificial neural network, the plurality of feature maps to recognize the object includes classifying the object.

In some aspects, the trained artificial neural network includes at least one of a pooling layer, a flattening layer, an activation layer, and a fully-connected layer.

In some aspects, the techniques described herein relate to a method including: imaging an object with a meta-imager configured for multi-channel convolution, wherein the meta-imager outputs a plurality of feature maps; inputting, into a trained artificial neural network, the plurality of feature maps; and processing, using the trained artificial neural network, the plurality of feature maps to recognize the object.

In some aspects, the step of imaging the object includes capturing incoherent light reflected from or emitted by the object.

In some aspects, the meta-imager is configured to optically implement convolutional operations.

In some aspects, the step of processing, using the trained artificial neural network, the plurality of feature maps to recognize the object includes detecting the object.

In some aspects, the step of processing, using the trained artificial neural network, the plurality of feature maps to recognize the object includes classifying the object.

In some aspects, the meta-imager includes a meta-optic, wherein a point spread function of the meta-optic comprises a plurality of focal spots, wherein the meta-optic is configured to encode each of the plurality of focal spots with a respective kernel weight, wherein a positively valued kernel weight is achieved by encoding a first focal spot with a first polarization state, and a negatively valued kernel weight is achieved by encoding a second focal spot with a second polarization state, and wherein the first and second polarization states are orthogonal polarization states.

In some aspects, the trained artificial neural network includes at least one of a pooling layer, a flattening layer, an activation layer, and a fully-connected layer.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates is schematic of a meta-optic accelerator for a machine vision system according to an implementation described herein. FIG. 1B illustrates design of a meta-optic accelerator for a machine vision system according to an implementation described herein.

FIG. 2 is a flow diagram illustrating a method of machine vision according to an implementation described herein.

FIG. 3 is an example computing device.

FIGS. 4A and 4B illustrate the meta-optic architecture according to an implementation described herein. FIG. 4A is a comparison between the digital and optical convolution process. A random 3×3 kernel, normalized between [−1,1], was defined to convolve an image digitally. The equivalent optical PSF was designed and simulated by the angular spectrum propagation method, with the optical output calculated based on the premise of a coma-free system. FIG. 4B illustrates the architecture of the compound meta-optic forms three independent focal spots as the PSF. Angular multiplexing is used in the first layer metasurface, which can split light into multiple signal channels and correct the wavefront for wide-view-angle imaging. Meanwhile, polarization multiplexing is used to realize an independent response for orthogonal polarization states. In our case right-hand-circular (RCP) and left-hand-circular (LCP) polarized signals are used for positive and negative kernel values, respectively.

FIGS. 5A and 5B illustrate the design of the meta-imager according to an implementation described herein. FIG. 5A illustrates the design process of the hybrid neural network. A shallow convolutional neural network was trained at first. In this case, the input is convoluted by 12 independent channels, each comprising 7×7 pixel kernels. The convolution operations are implemented using the meta-imager, with the extracted feature maps, including multiplexed polarization channels, recorded by a polarization-sensitive camera. The processed feature maps were then fed into the pre-trained digital neural network to obtain the probability histogram for image classification. The number at the corner indicates the percentage of relevant computing operations. FIG. 5B illustrates the schematic of the meta-atoms for the first and second metasurfaces. The height is fixed at 0.6 mm while the lattice constant is chosen as 0.45 mm and 0.47 mm, respectively.

FIGS. 6A-6E illustrate fabrication and characterization of the meta-imager. FIGS. 6A and 6B are optical images of the fabricated metasurfaces comprising the meta-imager. The inset is an SEM image of each metasurface. Scale bar: 5 mm. FIG. 6C illustrates an ideal optical kernel calculated based on the angular spectrum propagation method. The weight of each spot is equal to the pre-designed digital kernel. FIG. 6D illustrates the measured intensity profile of the kernel generated by the fabricated meta-optic. FIG. 6E illustrates the comparison between convolutional results based on the ideal and measured kernels. The solid white line indicates the sampled pixels for comparison. The demonstration kernel is the same as FIGS. 6C and 6D.

FIGS. 7A-7G illustrate classification of MNIST and Fashion-MNIST objects. FIG. 7A illustrates an input image from the MNIST dataset. FIG. 7B illustrates ideal and experimentally measured feature maps corresponding to the convolution of the input image of FIG. 7A with channels 1 and 4. The upper-left corner label indicates the channel number during convolution. FIG. 7C illustrates the comparison between the theoretical and measured confusion matrices for MNIST classification. FIG. 7D illustrates an input image from the Fashion-MNIST dataset. FIG. 7E illustrates ideal and experimentally measured feature maps corresponding to the convolution of the input image of FIG. 7D with channels 1 and 4. The upper-left corner label indicates the channel number during convolution. FIG. 7F illustrates the comparison between the theoretical and measured confusion matrices for Fashion-MNIST classification. FIG. 7G illustrates the predicted accuracy curve for the MNIST dataset and the areal density of basic computing unit as a function of pixel size. The insets depict kernel profiles and feature maps at different pixel sizes.

FIGS. 8A-8D illustrate a Wide View-angle Meta-optic. FIG. 8A is a 3D diagram of the bilayer metalens forming the meta-optic. FIG. 8B shows the phase profile of each metasurface, optimized by Zemax. FIG. 8C illustrates the focal spot shape and position in terms of the incident plane wave angle. The colored area indicates the designed angle range of the devices in the manuscript. FIG. 8D is the fitting diagram of the focal spot position based on the f·tan(θ) relationship.

FIGS. 9A and 9B are a demonstration of a wide FOV metalens system. FIG. 9A is the schematic of three layers meta-imager under ray-tracing calculation. FIG. 9B illustrates focal spot intensity profile in terms of the incident angle of illumination light.

FIGS. 10A and 10B illustrate the Point Spread Function Calculation for the Center Convolutional Channel. FIG. 10A is the diagram of the point response by an imager, with the focal spot of the 0° incident signal positioned at the aperture center. FIG. 10B illustrates the position prediction of the point spread function based on a linear approximation.

FIGS. 11A and 11B illustrate the Point Spread Function Calculation for an Off-Center Convolutional Channel. FIG. 11A is the diagram of the point response by an imager, with the focal spot of 0° incident signal positioned off the aperture center. FIG. 11B illustrates the position prediction of the point spread function based on a linear approximation.

FIGS. 12A and 12B illustrate the Design Process for the Meta-optic. FIG. 12A illustrates the design process of the angular multiplexing method for the first metasurface, for a particular polarization state. A multiplexed angular phase with an intensity corresponding to a weight forms a complex-amplitude profile. FIG. 12B illustrates the point spread function created by the meta-optic. An optimizer converts the complex-amplitude of the first metasurface into a phase-only version for high diffraction efficiency.

FIG. 13 illustrates the Accuracy Curves in terms of Training Epochs based on Kernel Restrictions.

FIG. 14 is Table S1, which illustrates Floating-point Operations of Each Layer in the Neural Network.

FIGS. 15A and 15B illustrate Polarization Multiplexing based on an Elliptical Silicon Nanopillar. FIG. 15A illustrates phase response along x and y axes and corresponding average transmission from the meta-atoms with different geometrical parameters, forming a data library. Inset shows the 3D diagram of the basic meta-atom. FIG. 15B illustrates the phase response based on LCP and RCP excitation for meta-atoms in FIG. 15A. The bottom panel indicates the phase difference between LCP and RCP excitation, controlled by the rotation angle, θ.

FIG. 16 illustrates Phase Delay of the Circular Silicon Nanopillars as a Function of the Diameter. The transmission coefficient is calculated by full-wave simulation under a working wavelength of 870 nm. The height of the nanopillars is fixed at 630 nm. The inset shows the structure of the unit cell with a period of 470 nm. The phase control can cover the entire 2× range with close-to-unity transmission.

FIGS. 17A-17C illustrate the Phase Profile of a Designed Meta-optic. FIGS. 17A and 17B illustrate the phase response under LCP and RCP excitation by the first metasurface, respectively.

FIG. 17C illustrates the polarization-insensitive phase response by the second layer metasurface. Inset shows the zoom-in phase profiles.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” or “approximately” when referring to a measurable value such as an amount, a percentage, and the like, is meant to encompass variations of ±20%, ±10%, ±5%, or ±1% from the measurable value.

As used herein, the term “metasurface” refers to a thin, artificially structured surface that can manipulate electromagnetic waves such as light in unique ways. For example, a metasurface has a plurality of subwavelength structures, typically much smaller than the wavelength of the waves it interacts with. The subwavelength structures are arranged in a specific pattern to control the properties of light passing through or reflecting off the surface. As non-limiting examples, a metasurface can manipulate properties including, but not limited to, polarization, wavelength, and/or angle of incidence of light passing through or reflecting off the surface.

As used herein, the term “incoherent light” refers to light including waves with random phase relationships. The waves in incoherent light therefore do not maintain a consistent alignment of peaks and troughs. Accordingly, incoherent light does not produce a well-defined interference pattern. Sources of incoherent light include, but are not limited to, sunlight and artificial light sources such as incandescent bulbs, light emitting diodes (LEDs), and compact fluorescent lamp (CFL) bulbs.

As used herein, the term “coherent light” refers to light including waves that have a fixed phase relationship with each other. The waves in coherent light are in sync, meaning their peaks and troughs align perfectly. Accordingly, coherent light exhibits interference phenomena such as diffraction and interference patterns, where waves reinforce or cancel each other out. Sources of coherent light include, but are not limited to, lasers.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of Al that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or target) during training with both labeled and unlabeled data.

As described above, machine learning technologies have rapidly developed in recent years at least in part due to the availability of large training dataset and advances in computing hardware. With these advancements, however, the complexity of machine learning models has increased, which results in increases in computing resources and/or energy costs. These issues are problematic for machine vision, particularly machine vision for autonomous systems where the imaging device and processor must have small size, weight, and power consumption for on-board processing while still maintaining low latency, high accuracy, and highly robust operation. The systems and methods described herein provide solutions for these issues. For example, the systems and methods described herein include a meta-optic configured to optically implement the convolutional layers at the front-end of a system including an artificial neural network (ANN). In other words, the meta-optic acts as a front-end while the ANN acts as a digital back-end. The systems and methods described herein therefore facilitate the off-load of computationally expensive convolution operations to high-speed and low-power optics.

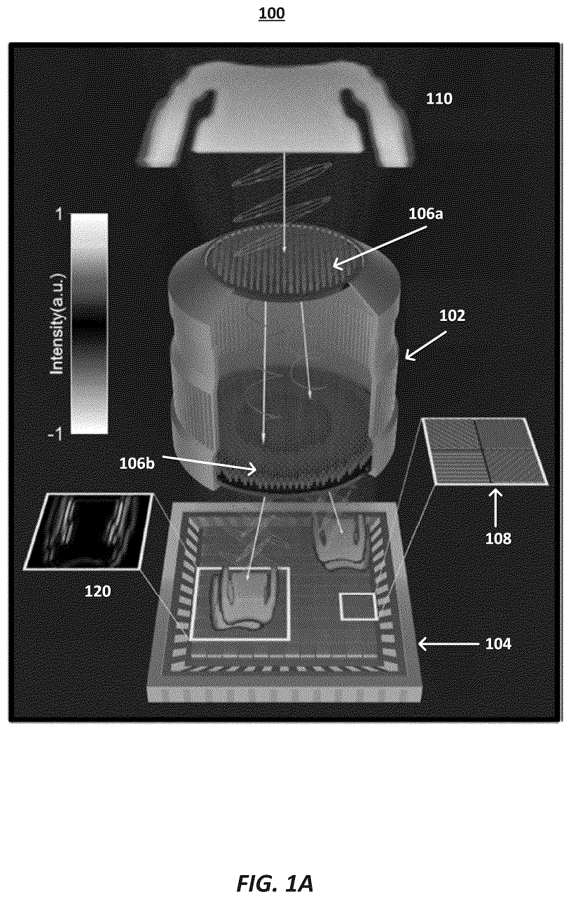

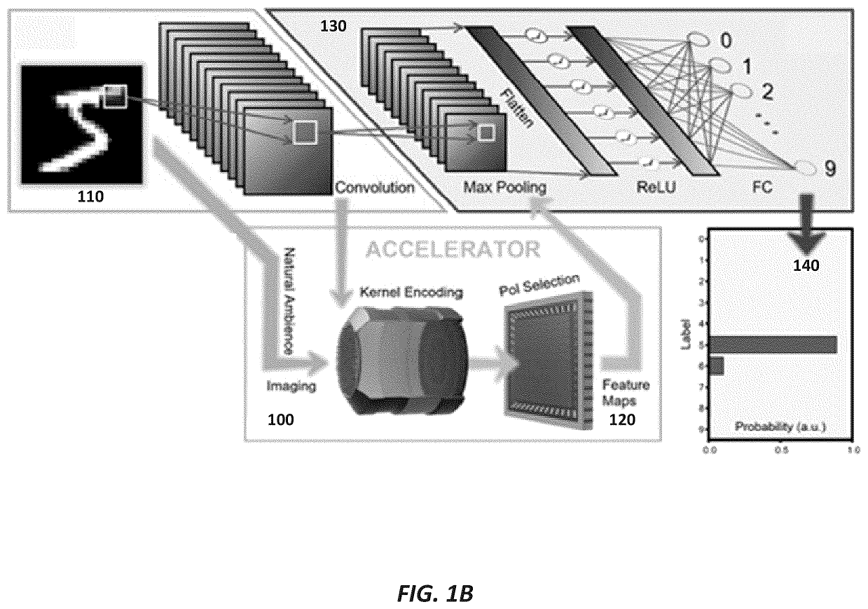

Referring now to FIGS. 1A and 1B, a machine vision system according to an implementation described herein is shown. The machine vision system shown in FIGS. 1A and 1B includes a meta-imager 100 including a meta-optic 102 and a polarization-sensitive photodetector 104. Optionally, the meta-imager includes a single aperture through which light enters the meta-imager. In the implementations described herein, the light is incoherent light.

The meta-optic 102 includes one or more metasurfaces. A metasurface is an artificially structured surface, for example a surface having an array of subwavelength structures, that is configured to control the properties of light passing through or reflecting off the surface. In some implementations, the meta-optic 102 includes a first metasurface 106a configured for angular multiplexing and polarization multiplexing. Additionally, the meta-optic 102 includes a second metasurface 106b configured for configured for focusing. Example metasurfaces are described in the Examples below. It should be understood that these are provided only as examples. This disclosure contemplates providing metasurfaces other than those described in the Examples.

The meta-optic 102 is configured to optically implement at least one convolutional layer for the machine vision system. The meta-optic 102 is therefore the component that facilitates off-loading computationally expensive convolution operations from the digital ANN. In other words, convolutional operations are performed optically by the meta-optic 102 as opposed to being performed digitally by the ANN. Additionally, a point spread function of the meta-optic 102 includes a plurality of focal spots, wherein the meta-optic 102 is configured to encode each of the plurality of focal spots with a respective kernel weight. Optionally, the plurality of focal spots include an N×N focal spot array, where N is an integer. In the Examples, N=3. It should be understood that N can have other values. Additionally, as described herein, kernel weights can have both positive and negative values. For example, a positively valued kernel weight is achieved by encoding a first focal spot with a first polarization state, and a negatively valued kernel weight is achieved by encoding a second focal spot with a second polarization state, wherein the first and second polarization states are orthogonal polarization states. In some implementations, the first polarization state is one of right-hand-circular polarization (RCP) or left-hand-circular polarization (LCP), and the second polarization state is the other of RCP or LCP. Alternatively, in other implementations, the first and second polarization states are orthogonal linear polarization states, for example vertical linear polarization and horizontal linear polarization.

As shown in FIG. 1A, the meta-imager 100 also includes the polarization-sensitive photodetector 104. A photodetector is a device that detects light and converts it into an electrical signal. Photodetectors include, but are not limited to, photodiodes, phototransistors, avalanche photodiodes, and photomultiplier tubes. A polarization-sensitive photodetector is a photodetector that is sensitive to the polarization state of light. Light is an electromagnetic wave, and its electric field oscillates in a specific plane as it propagates. Polarization-sensitive photodetectors are therefore designed to detect changes in the orientation of this electric field. A photodetector can be made sensitive to the polarization state of light through various methods, including the design of the detector structure and the integration of polarization-sensitive elements. As non-limiting examples, polarization sensitivity can be achieved by selection of materials (e.g. anisotropic materials having different optical properties depending on direction of light polarization), incorporation of waveguides or gratings sensitive to the direction of light polarization, and/or use of polarization filters. Optionally, in some implementations, a plurality of directional gratings 108 are integrated into each pixel of the polarization-sensitive photodetector 104. For example, a directional grating can be arranged on each photodetector pixel for polarized signal sorting as shown in FIGS. 1A and 1B. An example polarization-sensitive photodetector is described in the Examples below. It should be understood that this is provided only as an example. This disclosure contemplates providing a polarization-sensitive photodetector other than those described in the Examples.

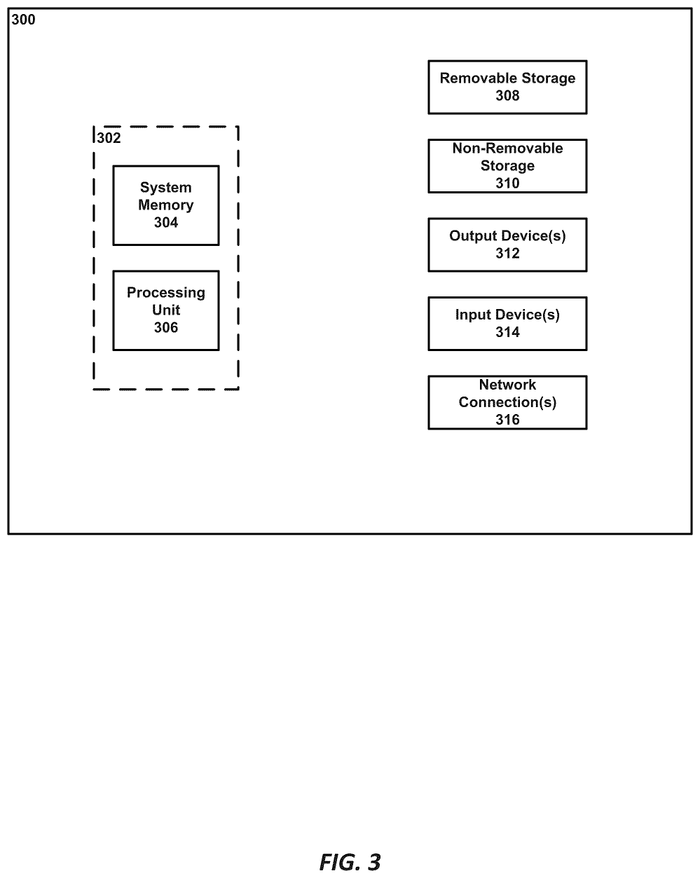

The machine vision system also includes at least one processor and at least one memory. The at least one processor and at least one memory can optionally have the basic configuration illustrated in FIG. 3 by box 302. Optionally, the at least one processor and at least one memory are part of a computing device such as computing device 300 illustrated in FIG. 3. The at least one processor is operably coupled to the polarization-sensitive photodetector 104. The at least one processor and the polarization-sensitive photodetector 104 can be coupled through one or more communication links. This disclosure contemplates the communication links are any suitable communication link. For example, a communication link may be implemented by any medium that facilitates data exchange including, but not limited to, wired, wireless and optical links. Thus, the polarization-sensitive photodetector 104 detects light and converts it into an electrical signal, which is transmitted to the at least one processor via the one or more communication links.

The machine vision system can be used to image an object 110. In FIG. 1A, the object 110 is a fashion item. In FIG. 1B, the object 110 is a handwritten digit (i.e. 5). In the Examples, the objects are handwritten digits from the Modified National Institute of Standards and Technology (MNIST) dataset and fashion items (e.g. T-shirts, trousers, dresses, sneakers, and handbags) from the Fashion-MNIST dataset. It should be understood that handwritten digits and fashion items are provided only as example objects. This disclosure contemplates that the object 110 can be objects other than handwritten digits and fashion items. The object 110 is imaged by creating a visual representation of the object 110. For example, imaging refers to capturing the optical information of the object 110 and producing a visual representation of it, e.g. on the polarization-sensitive photodetector 104. Imaging involves using optical devices such as the meta-imager 100 to focus and capture incoherent light reflected or emitted by the object 110, resulting in an image that can be observed, analyzed, or stored for various purposes.

As described herein, the at least one processor can be configured to receive, from the polarization-sensitive photodetector 104, a plurality of feature maps 120. The plurality of feature maps 120 encode the focal spots with orthogonal polarization states. As a result, both positive and negative value kernel weights are achieved. Additionally, the at least one processor can be configured to input, into a trained artificial neural network 130, the plurality of feature maps 120. The at least one processor can be further configured to process, using the trained artificial neural network 130, the plurality of feature maps 120 to recognize an object. The trained artificial neural network 130 outputs a prediction 140, which is recognition of the object. In some aspects, the prediction 140 is detection of the object. Alternatively, the prediction 140 is classification of the object.

In FIG. 1B, the trained artificial neural network 130 is operating in inference mode. The artificial neural network 130 has therefore been trained with a data set (or “dataset”) and is configured to make predictions based on new input data. For example, in FIG. 1B, the artificial neural network 130 has been trained using the MNIST dataset. In other words, the artificial neural network 130 shown in FIG. 1B has been trained to recognize handwritten digits. Accordingly, such a trained model is sometimes referred to herein as a “trained AI model” or a “deployed Al model.” It should be understood that artificial neural networks can be trained to recognize objects other than handwritten digits.

As described above, an artificial neural network is a supervised machine learning model that “learns” a function that maps an input (also known as feature or features) to an output (also known as target or targets) during training with a labeled data set. Machine learning model training is discussed in further detail below. In some implementations, a trained supervised machine learning model is configured to classify the input into one of a plurality of target categories (i.e., the output). In other words, the trained model can be deployed as a classifier. In other implementations, a trained supervised machine learning model is configured to provide a probability of a target (i.e., the output) based on the input. In other words, the trained model can be deployed to perform a regression.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. ANNs are known in the art and are therefore not described in further detail herein.

A convolutional neural network (CNN) is a type of deep neural network that has been applied, for example, to image analysis applications. Unlike a traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similar to traditional neural networks.

In some implementations, the trained artificial neural network 130 includes at least one of a pooling layer, a flattening layer, an activation layer, and a fully-connected layer as shown in FIG. 1B. As described above, the convolutional layers are implemented by the meta-imager 100, and the remaining layers are implemented computationally. It should be understood that the architecture of the CNN shown in FIG. 1B is provided only as an example. This disclosure that the trained artificial neural network 130 can include a different number and/or arrangement of layers than the network shown in FIG. 1B.

As described above, the artificial neural network 130 is trained to map the input to the output. In FIG. 1B, the input is the plurality of feature maps 120 associated with a handwritten digit (i.e. 5), and the output is a predicted recognition of the handwritten digit. In FIG. 1B, the prediction 140 is a probability of the handwritten digit being the digit 0, 1, 2, . . . 8, or 9. The plurality of feature maps 120 includes one or more “features” that are input into the trained artificial neural network 130, which predicts the recognition of the handwritten digit. The prediction 140 is therefore the “target” of the trained artificial neural network 130.

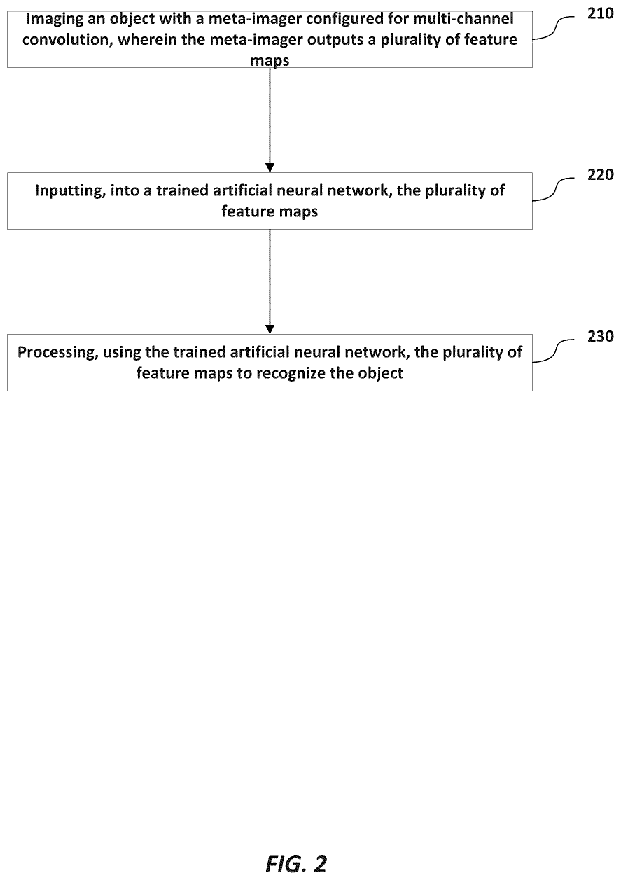

FIG. 2 a flow diagram illustrating a method of machine vision is shown. This disclosure contemplates performing the method using the system described with respect to FIGS. 1A and 1B.

At step 210, an object is imaged with a meta-imager (e.g., meta-imager 100 of FIGS. 1A and 1B) configured for multi-channel convolution. An object is imaged by creating a visual representation of the object. For example, imaging refers to capturing the optical information of the object and producing a visual representation of it. Imaging involves using optical devices to focus and capture incoherent light reflected or emitted by the object, resulting in an image that can be analyzed for various purposes. As described herein, the meta-image outputs a plurality of feature maps (e.g. feature maps 120 of FIGS. 1A and 1B), which encode the focal spots with orthogonal polarization states. As a result, both positive and negative value kernel weights are achieved. At step 220, the plurality of feature maps are input into a trained artificial neural network (e.g. trained artificial neural network 130 of FIG. 1B). At step 230, the plurality of feature maps are processed by the trained artificial neural network to recognize the object.

It should be appreciated that the logical operations described herein with respect to the various figures may be implemented (1) as a sequence of computer implemented acts or program modules (i.e., software) running on a computing device (e.g., the computing device described in FIG. 3), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 3, an example computing device 300 upon which the methods described herein may be implemented is illustrated. It should be understood that the example computing device 300 is only one example of a suitable computing environment upon which the methods described herein may be implemented. Optionally, the computing device 300 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 300 typically includes at least one processing unit 306 and system memory 304. Depending on the exact configuration and type of computing device, system memory 304 may be volatile (such as random access memory (RAM)), non-volatile (such as read-only memory (ROM), flash memory, etc.), or some combination of the two. This most basic configuration is illustrated in FIG. 3 by box 302. The processing unit 306 may be a standard programmable processor that performs arithmetic and logic operations necessary for operation of the computing device 300. The computing device 300 may also include a bus or other communication mechanism for communicating information among various components of the computing device 300.

Computing device 300 may have additional features/functionality. For example, computing device 300 may include additional storage such as removable storage 308 and non-removable storage 310 including, but not limited to, magnetic or optical disks or tapes. Computing device 300 may also contain network connection(s) 316 that allow the device to communicate with other devices. Computing device 300 may also have input device(s) 314 such as a keyboard, mouse, touch screen, etc. Output device(s) 312 such as a display, speakers, printer, etc. may also be included. The additional devices may be connected to the bus in order to facilitate communication of data among the components of the computing device 300. All these devices are well known in the art and need not be discussed at length here.

The processing unit 306 may be configured to execute program code encoded in tangible, computer-readable media. Tangible, computer-readable media refers to any media that is capable of providing data that causes the computing device 300 (i.e., a machine) to operate in a particular fashion. Various computer-readable media may be utilized to provide instructions to the processing unit 306 for execution. Example tangible, computer-readable media may include, but is not limited to, volatile media, non-volatile media, removable media and non-removable media implemented in any method or technology for storage of information such as computer readable instructions, data structures, program modules or other data. System memory 304, removable storage 308, and non-removable storage 310 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 306 may execute program code stored in the system memory 304. For example, the bus may carry data to the system memory 304, from which the processing unit 306 receives and executes instructions. The data received by the system memory 304 may optionally be stored on the removable storage 308 or the non-removable storage 310 before or after execution by the processing unit 306.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

As described above, the deployment of digital neural networks in the field of machine vision, particularly for autonomous systems, necessitates the development of new hardware and software solutions as the demands on machine vision systems continue to grow. Optics has long been studied as a way to speed computational operations while also increasing energy efficiency^{10, 11, 12, 13, 14, 15, 16}. In accelerating vision systems there is the unique opportunity to off-load computation into the front-end imaging optics by designing an imager that is optimized for a particular computational task. Free-space optical computational, based on Fourier optics^{17, 18, 19, 20}, actually predates modern digital circuitry and allows for highly parallel execution of the convolution operations which comprise the majority of the floating point operations (FLOPs) in machine vision architectures^{21, 22}. The challenge with Fourier-based processors is that they are traditionally employed by reprojecting the imagery using spatial light modulators and coherent sources, enlarging the system size compared to chip-based approaches^{23, 24, 25, 26, 27, 28}. While coherent illumination is not strictly required, it allows for more freedom in the convolution operations including the ability to achieve the negatively valued kernels needed for spatial derivaties. Optical diffractive neural networks^{29, 30, 31} offer an alternative approach though these are also employed with coherent sources and thus are best suited as back-end processors with image data being reprojected.

Metasurfaces offer a unique platform for implementing front-end optical computation as they can reduce the size of the optical elements while allowing for a wider range of optical properties including polarization^{32, 33}, wavelength^{34, 35}, and angle of incidence^{36, 37} to be utilized in computation. For instance, metasurfaces have been demonstrated with angle of incidence dependent transfer functions for realizing compact optical differentiation systems^{38, 39, 40, 41} with no need to pass through the Fourier plane of a two lens system. In addition, wavelength multiplexed metasurfaces, combined with optoelectronic subtraction, have be used to achieve negatively valued kernels for executing single-shot differentiation with incoherent light^{42, 43}. Differentiation, however, is a single convolution operation while most machine vision systems require multiple independent channels. There has been recent work on multi-channel convolutional front-ends but these have been limited in transmission efficiency and computational complexity, achieving only positively valued kernels with a stride that is equal to the kernal size, preventing implementation of common digital designs^{44, 45}. While these are important steps towards a computational front-end, an architecture is still needed for generating the multiple independent, and arbitrary, convolution channels that are used in machine vision systems.

Described herein is a meta-imager that can serve as a multi-channel convolutional accelerator for incoherent light. To achieve this, the point spread function (PSF) of the imaging meta-optic is engineered to achieve parallel multi-channel convolution using a single aperture implemented with angular multiplexing, as shown in FIG. 1A. The meta-imager shown in FIG. 1A enables multi-channel signal processing for replacing convolution operations in a digital neural network. A bilayer meta-optic system encoded by the pre-designed kernels is utilized to achieve optical convolution with the incoherent light source to be used for object illumination. Positive and negative values are distinguished and recorded as feature maps by a polarization-sensitive photodetector, where an oriented grating sits on each photodetector pixel for polarized signal sorting. Positively and negatively valued kernels are achieved for incoherent illumination by using polarization multiplexing⁴⁶, combined with a polarization-sensitive camera and optoelectronic subtraction. A second metasurface corrector is also employed to widen the field of view (FOV) for imaging objects in the natural world and both metasurfaces are restricted to phase functions, yielding high transmission efficiency. The platform is used to experimentally demonstrate classification of the MNIST and Fashion-MNIST datasets⁴⁷ with measured accuracies of 98.6% and 88.8%, respectively. In both cases, 94% of the operations are off-loaded from the digital platform into the front-end optics.

### Angular and Polarization Multiplexing

The meta-optic described here is designed to optically implement the convolutional layers at the front-end of a digital neural network. In a digital network, convolution comprises matrix multiplication of the object image and an N×N pixel kernel with each pixel having an independent weight, as illustrated for the case of N=3 in FIG. 4A. The kernel is multiplied over an area of the image using a dot product and then rastered across the image, moving by a single pixel each step until it is swept across the entire image, forming a single feature map. Under incoherent illumination, optical convolutional is expressed as Image=Object ⊗|PSF(x,y)| where PSF(x,y) is the point spread function of the optic. Typically, in implementing the optical version of digital convolution the PSF(x,y) is the continuous function that was discretized in forming the digital kernel. Here, we take a different approach, creating a true optical analog to the digital kernel. This is done by engineering the PSF(x,y), as shown in FIG. 4A, to possess N×N focal spots, each with a different weight, or image intensity, that matches the desired digital kernel weight. These focal spots will result in N×N images of the object being formed that are spatially overlapped on the sensor and offset based on the separation in the focal spot positions. In this case, we are rastering weighted images with the summing operation in the dot product being achieved by overlapping the images on the camera.

In this architecture, positively and negatively valued kernel weights are achieved by encoding the focal spots with either right-hand-circular polarization (RCP) or left-hand-circular (LCP), respectively. The circular-polarized signal is decoded by using a quarter waveplate (QWP) combined with a polarization-sensitive camera containing four directional gratings integrated onto each pixel. The RCP and LCP encoded feature maps, shown in FIG. 4A, are then independently recorded using the polarization-sensitive camera with summing being achieved by digitally subtracting the LCP feature map from the RCP feature map. The convolution generated by this method is identical to the digital process which is evidenced by comparing the digital and optical feature maps in FIG. 4A. We have used this approach for several reasons. First, as will be explained, the phase and amplitude profile associated with our desired PSF(x,y) is analytical, significantly simplifying the design process and allowing us to achieve numerous independent feature maps, or channels, using one aperture. In addition, since we have a true optical analog to a digital system, we can directly implement digital kernel designs with optics, removing the optic from the design loop, further speeding the design process. In order to achieve the desired optical response, we employ a bilayer metasurfaces architecture, as shown in FIG. 4B. In this architecture, the first metasurface splits the incident signal into angular channels of varying weight while birefringence in this layer is used to encode positive and negative kernel values in RCP and LCP polarization, respectively. The second metasurface is polarization insensitive and serves as the focusing optic to create a N×N focal spot array for each channel.

### Meta-Optic Design

Meta-optic design began by optimizing a two metasurface lens, comprising a wavefront corrector and focuser, to be coma-free over a ±10° angular range using the commercial software, Zemax (see details in Methods). The phase profiles and angular response of the metasurfaces can be found below (see details in Compound Metalens for Wide View-angle Imaging), which shows constant focal spot shape within the designed angular range. Wider FOV can be achieved by further cascading metasurfaces as shown below (see details in Increased FOV in Cascaded Metalens Design). Once the coma-free meta-optic was designed, angular multiplexing was applied to the first metasurface to form focal spot arrays as the convolution kernels. The focal spot position is controlled using angular multiplexing with each angle corresponding to a kernel pixel. By encoding a weight to each angular component, the system PSF, serving as the optical kernel, can be readily engineered. The analytical expression of the complex-amplitude profile multiplexing all angular signals is given by,

$$A ( x , y ) = {\sum }_{m}^{M} {\sum }_{n}^{N} \sqrt{{w}_{m n}} exp \{ i \frac{2 π}{λ} [ x sin ( {θ}_{x \vert m n} ) + y sin ( {θ}_{y \vert m n} ) ] \} \qquad ( 1 )$$

where A(x,y) is a complex-amplitude field. M, N is the row and column number of elements in the kernel. wₘₙ is the corresponding weight of each element, which is normalized to a range of [0,1]. λ is the working wavelength, x and y are the spatial coordinates, and θ_{x|mn} and θ_{y|mn} are the designed angles with a small variation to form the kernel elements. The deflection angles are selected to realize the desired PSF for incoherent light illumination which is given by,

$$P S F ( x , y ) = {\sum }_{m}^{M} {\sum }_{n}^{N} {w}_{m n} Θ \{ x - {f}_{1} c [ \frac{{x}_{0}}{{f}_{2}} + tan ( {θ}_{x \vert m n} ) ] , y - {f}_{1} c [ \frac{{y}_{0}}{{f}_{2}} + tan ( {θ}_{y \vert m n} ) ] \} \qquad ( 2 )$$

where x₀ and y₀ are the location of the object and Θ(x,y) is the focal spot excited by a plane wave. f₁ is focal length of the meta-imager while c is a constant fitted based on the imaging system. f₂ is the distance from the object to the front aperture. The detailed derivative can be found below (see details in Point Spread Function for Center Channel). The separation distance of each focal spot, Δp, defines the imaged pixel size of the object. Based on a prescribed PSF the required angles, θₘₙ, can be derived from Eq. 2, which can be further extended into an off-axis imaging case, as exhibited below (see details in Point Spread Function for Off-Center Channels), for the purpose of multi-channel, single-shot convolutional applications.

In Eq. 1 we employ a spatially varying complex-valued amplitude function (see the workflow of the design process below (see details in Design Process for Meta-optic)) that would ultimately introduce large reflection loss leading to a low diffraction efficiency⁴⁸. To overcome this limitation, an optimization platform was developed based on the angular spectrum propagation method and stochastic gradient descent (SGD) solver, which converts the complex-amplitude profile into a phase-only metasurface. The algorithm encodes a phase term, exp(iϕₘₙ), onto each weight, wₘₙ, based on the loss function, [symbol] =Σ(|A|²−l)²/N. Here, l is a matrix consisting of unity elements and N is the total pixel number. The intensity profile becomes more consistent and closer to a phase-only device by minimizing the loss function during optimization (see details in Optimization Algorithm for Phase-only Approximation). The phase-only approximation can effectively avoid loss in the complex-amplitude function, leading to a theoretical diffraction efficiency as high as 84.3% where 14% of the loss is introduced by Fresnel reflection, which can be removed by adding anti-reflection coatings.

### Hybrid Neural Network for Object Classification

In order to validate the performance of this architecture, a shallow CNN was trained for the purpose of image classification. The neural network architecture, shown in FIG. 5A, contains an optical convolution layer followed by digital max pooling, a rectified linear (ReLU) activation function, and a fully connected (FC) layer. In the convolution process, 12 independent kernels are used to extract feature maps and the overall intensity of positive and negative channels was set to be equal due to energy conservation from the phase-only approximation in the meta-optic design. Since neural network training is a high-dimensional problem with infinite solutions, the above kernel restrictions do not significantly affect the final performance (see details in Normalization of Kernels for Neural Networks). Each kernel comprised N=7 pixels instead of a more typical N=3 format, to correlate neurons within a broader viewing field⁴⁹, leading to better performance for large-scale object recognition. The detailed training process is described in the Methods section below. In order to finish classification, the feature maps extracted by the compound meta-optic are fed into the digital component of the neural network. In this architecture 94% of the total operations are off-loaded from the digital platform into the meta-optic leading to a significant speedup for classification tasks (see details in Floating-point Operations in Convolutional Neural Network).

### Meta-Optic Implementation

To realize the first, polarization selective metasurface, elliptical nanopillars were chosen as the base meta-atoms, as shown in FIG. 5B. The width and length of nanopillars were designed so that the nanopillars serve as half-wave plates. This choice introduces spin-decoupled phase response by introducing geometrical and a locally-resonant phase delay simultaneously, hence independent phase control over orthogonal circular-polarized states can be achieved. The analytical expression of the phase delay for the different polarization states is described as,

$$[ \begin{matrix}{ϕ}_{LCP} \\ {ϕ}_{RCP}\end{matrix} ] = [ \begin{matrix}{ϕ}_{x} & + 2 θ & + π / 4 \\ {ϕ}_{x} & - 2 θ & - π / 4\end{matrix} ] \qquad ( 3 )$$

Here, ϕₓ is the phase delay of the meta-atoms along x axis at θ=0. Hence, by tuning the length, width, and rotation angle, the phase delay of LCP and RCP light can be independently controlled (see details in Polarization Multiplexed Phase Response of Birefringent Meta-atoms). The second metasurface was designed based on circular nanopillars arranged in a hexagonal lattice for realizing polarization-insensitive phase control. The phase delay of the circular nanopillars as a function of diameter can be found below (see details in Phase Response of Circular Nanopillars).

### Fabrication and Characterization of Meta-Optic

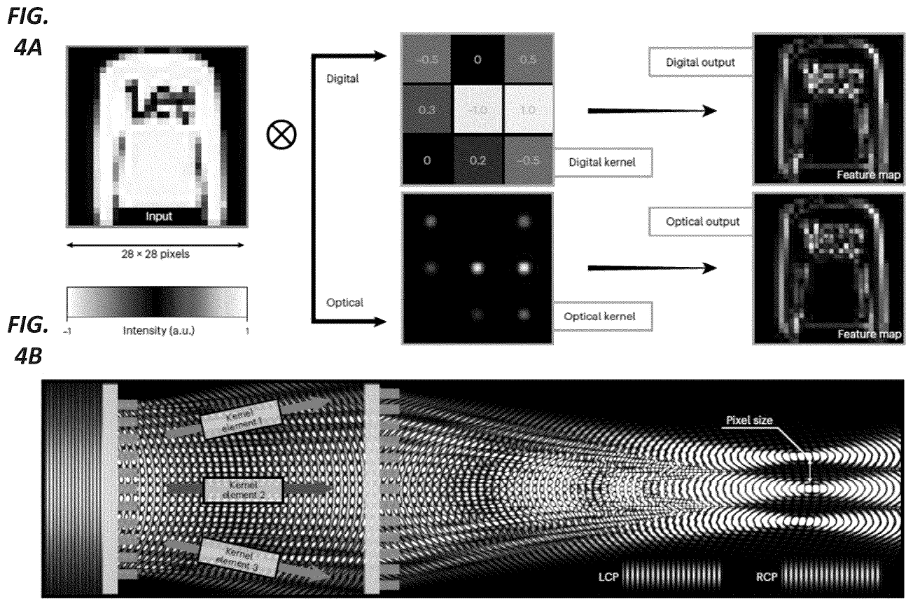

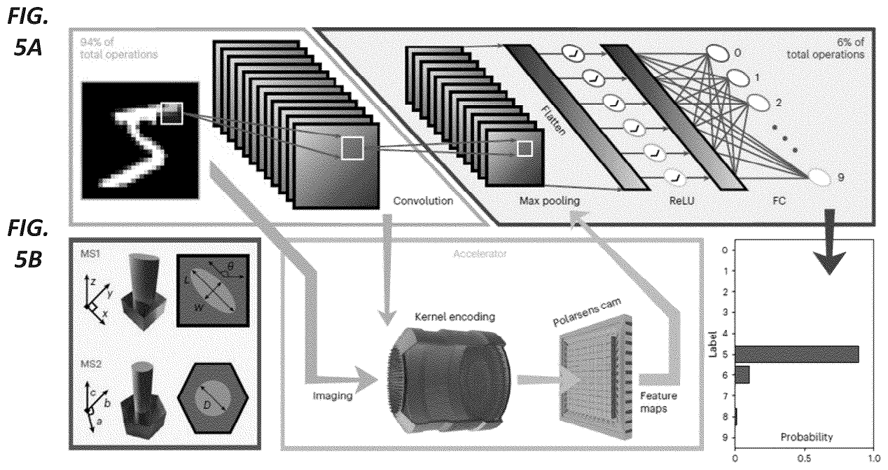

Two versions of the meta-optic classifier were fabricated based on networks trained for MNIST and Fashion-MNIST datasets, with one set of the phase profiles shown below (see details in Phase Profile of Meta-optic). Fabrication of the meta-optic began with a silicon device layer on a fused silica substrate patterned by the standard electron beam lithography (EBL) followed by reactive-ion-etching (RIE). A thin polymethyl methacrylate (PMMA) layer was spin-coated over the device as the protective and index-matching layer. The detailed fabrication process is described in the Methods section. An optical image of the two metasurfaces comprising the meta-optic is exhibited in FIGS. 6A and 6B with the inset showing the meta-atoms. In order to align the compound meta-optic, the first metasurface was mounted in a rotational stage (CRM1PT, Thorlabs) while the second layer was fitted in a 3-axis translational stage (CXYZ05A, Thorlabs). The metasurfaces are aligned in situ and characterized in a cage system, with the detailed alignment setup shown in supplementary note S12 of Zheng, H., Liu, Q., Kravchenko, I. I. et al. Multichannel meta-imagers for accelerating machine vision. Nat. Nanotechnol. 19, 471-478 (2024), which is incorporated herein by reference in its entirety (hereinafter “Zheng et al. (2024)”). A meta-hologram was fabricated on the first layer alongside the device to assist the alignment process by forming an alignment pattern at a prescribed distance along the optical axis corresponding to the designed separation distance. The alignment process was finished by overlapping the alignment pattern with the low-transmission register on the second layer. Due to the large size (mm-scale) of each metasurface layer, the meta-optic exhibits high alignment tolerance. The system performance remains constant under a horizontal misalignment of 65 mm and vertical displacement of ±400 mm, indicating the robustness of the entire convolutional system. The alignment error analysis can be found in supplementary note S13 of Zheng et al. (2024). FIG. 6C illustrates an ideal optical kernel calculated based on the angular spectrum propagation method.

In order to characterize the optical properties of the fabricated meta-optic, a linearly polarized laser was used for illumination in obtaining the PSF (see the detailed characterization setup in supplementary note S14 of Zheng et al. (2024)). The linearly polarized light source includes LCP and RCP components with equal strength. The PSF at the focal plane of the compound meta-optic, shown in FIGS. 6D and 6E, indicates a good match between the ideal and measured results, where the red and blue represent positive and negative values, respectively.

Optical convolution of a grayscale Vanderbilt logo was used to characterize the accuracy of the fabricated meta-optic, as shown in FIG. 6E. To accomplish this, an imaging system using a liquid-crystal-based spatial light modulator (SLM) was built with the details shown in supplementary note S15 of Zheng et al. (2024). An incoherent tungsten lamp with a 10 nm wide bandpass filter was used for SLM illumination. The feature maps extracted by the meta-optic were recorded by a polarization-sensitive camera (DZK 33UX250, Imaging Source) where orthogonally polarized channels are simultaneously recorded using polarization filters on each camera pixel. The comparison between the digital and measured feature maps, recorded on the camera, is illustrated in FIG. 6E. The pixel intensity from digital and measured convolutional results at the same position were extracted and compared to evaluate the convolution fidelity. The deviation between the ideal and measured results, defined by σ=Σₙ₌₁^{N}|D_{i,n}−D_{m,n}/(2N), was calculated as 3.83%, where Dᵢ and Dₘ are the ideal and measured intensity, and N is the number of total pixels. The error originates from stray light, fabrication imperfections, the local phase approximation, and metasurface misalignment (see the detailed system error analysis in supplementary note S16 of Zheng et al. (2024)). These errors also result in a small amount of zeroth order diffracted light being introduced from the first metasurface leading to a spot at the center of the imaging plane. However, the polarization state of the zeroth order light remains unchanged, with the energy evenly distributed in the two circular polarized channels. Hence, subtraction between the information channels allows the zeroth order pattern to be canceled, not affecting the classification performance. The detailed discussion can be found in supplementary note S17 of Zheng et al. (2024).

### Object Classification for Machine Vision

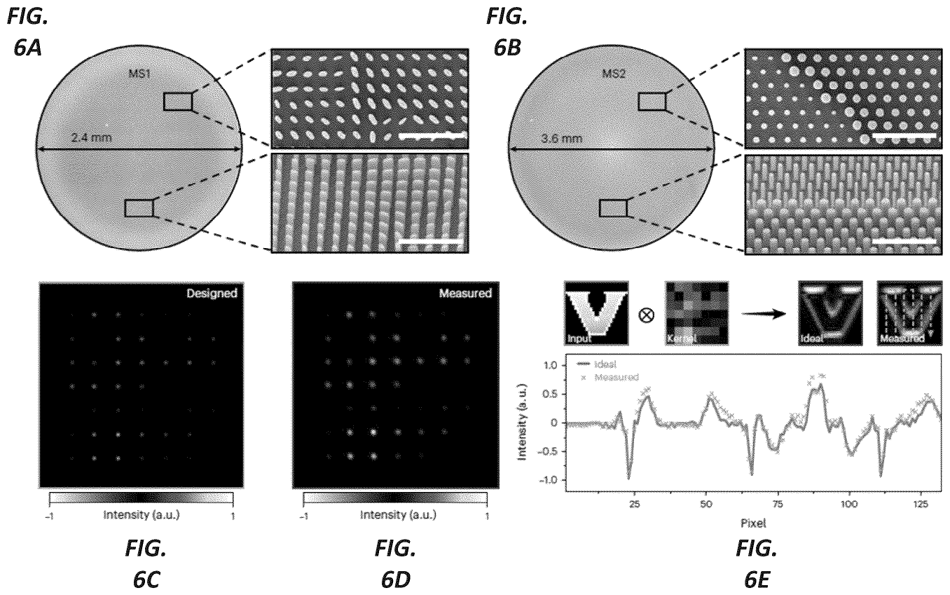

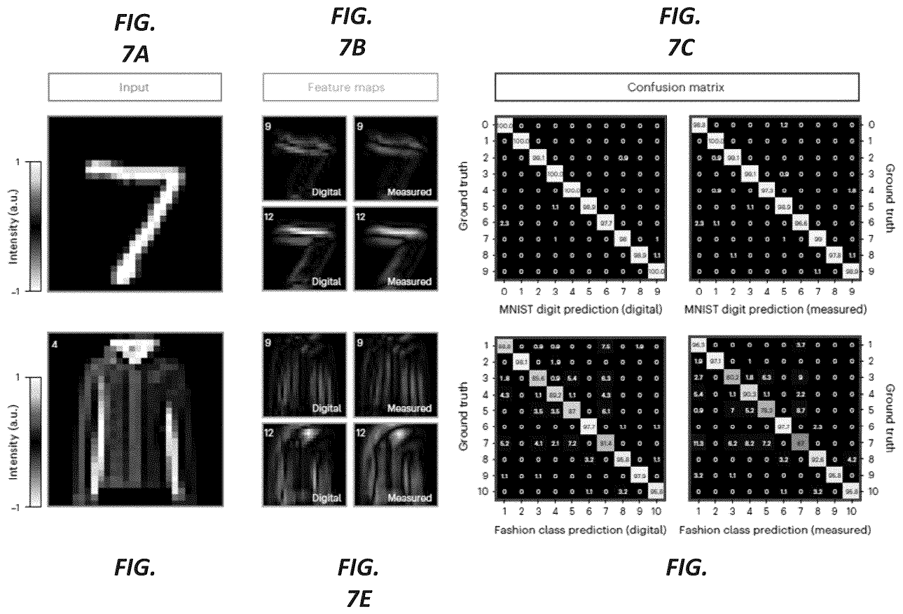

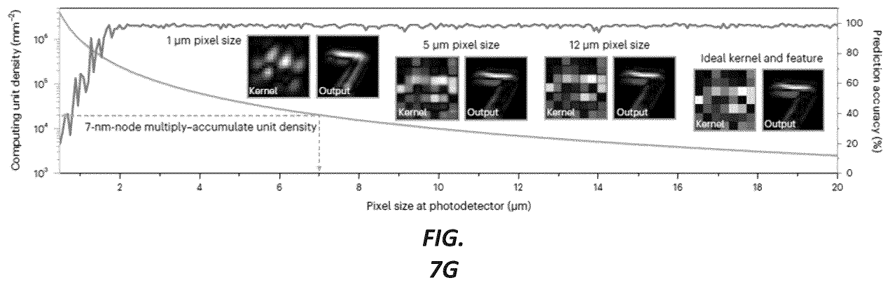

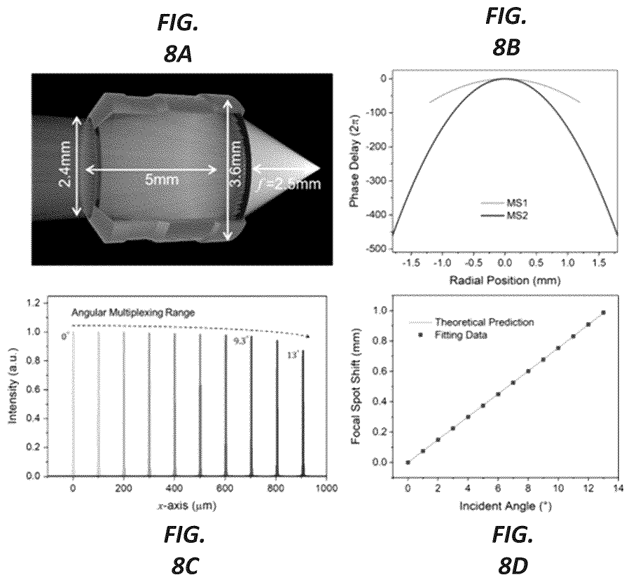

As a proof-of-concept in demonstrating multi-channel convolution, a full meta-optic classifier was first designed and fabricated based on classification of the MNIST dataset, which includes 60,000 hand-written digit training images with 28×28 pixel format. The feature maps of 1000 digits, not in the training set, were extracted using the meta-optic to characterize the system performance. An example input image is exhibited in FIG. 7A, with the corresponding feature maps shown in FIG. 7B. The kernels and feature maps for all the channels are illustrated in supplementary note S18 of Zheng et al. (2024). The measured feature maps match well with the theoretical prediction, as shown in FIG. 7B, indicating good fidelity in the optical convolution process. The theoretical and experimental confusion matrices for this testing dataset are shown in FIG. 7C, demonstrating 99.3% accurate classification in theory and 98.6% accurate classification in the measurement. The small drop in accuracy likely results from the small inaccuracy in the realized optical kernels. While the system was designed at a single wavelength, simulations indicate minimal accuracy drop up to an illumination bandwidth of 50 nm, indicating that the experimental bandwidth of 10 nm should have a minimal impact (see detailed discussion in supplementary note S19 of Zheng et al. (2024)).

In order to explore the flexibility of the approach a dataset with higher spatial frequency information, Fashion-MNIST, was also used for training the model with an example input image provided in FIG. 7D. This dataset includes 60,000 training images of clothing articles that contain images with higher spatial frequencies than the MNIST handwritten digit dataset. The ideal and measured feature maps are compared in FIG. 7E, indicating good agreement. All of the designed kernel profiles and feature maps are shown in supplementary note S20 of Zheng et al. (2024). The confusion matrices for Fashion-MNIST are illustrated in FIG. 7F, with 90.2% accurate classification in theory and 88.8% in measurement. To validate the significance of the optical convolution layer, a reference model for MNIST handwritten digit classification, without a convolutional layer, was trained, resulting in an accuracy of 80.3%, illustrating the importance of the convolution operations (see detailed discussion in supplementary note S21 of Zheng et al. (2024)). Compared to the MNIST dataset, the Fashion-MNIST model has a slightly lower accuracy, in theory, due to the higher resolution features in the dataset. Specifically, for class 7 in the Fashion-MNIST dataset, the accuracy predicted by the optical frontend dropped from 81.4% to 67.0%, with the model miss-identifying the images as classes 1,3,4,5. We expect these classes to share the same features during model training (see discussion in the supplementary note S22 of Zheng et al. (2024)). These mixed features can be potentially distinguished by adaptively tuning the loss function during model training⁵⁰ or utilizing novel neural network architecture such as vision transformer⁵¹ (ViT) with better performance at comparable FLOPs.

To understand the scalability of the meta-imager, the accuracy of classification as a function of the areal density of the basic computing unit was calculated, as shown in FIG. 7G. The optical computing unit density is defined as the convolutional pixels per unit area where we assume each convolutional pixel is matched to a physical pixel on a photodetector. The pixel size is dictated by the separation distance between the neighboring focal spots in the PSF, which is ultimately dictated by the diffraction limit. The prediction accuracy is based on the MNIST dataset and the theoretical accuracy remains as high as ˜99% until the pixel size drops below 2 mm, at which point neighboring focal spots are below the diffraction limit, resulting in additional aberration in the output features, as shown in the inset images in FIG. 7G. Thus, although a pixel size of 12 mm is demonstrated in this work as a proof of concept, the system functionality would remain unchanged, in theory, with up to 6× higher areal computing unit density. For perspective, the meta-imager computing unit density can be compared to the multiply-accumulation (MAC) unit density and size based on the current 7 nm node architecture⁵², which results in MACs with a size of ˜7 μm×7 μm.

### CONCLUSIONS

Our meta-imager is a convolutional front-end that can be used to replace the traditional imaging optics in machine vision applications, encoding information in a more efficient basis for back-end processing. In this context, negatively valued kernels and multi-channel convolution, enabled by meta-optics, allows one to increase the number of operations that can be off-loaded into the front-end optics. Furthermore, the architecture allows for incoherent illumination and a reasonably wide FOV, both of which are needed for implementation in imaging natural scenes with ambient illumination. Although a tradeoff exists between the channel number and the viewing angle range, a multi-aperture architecture could be designed without deteriorating the FOV in a single imaging channel⁵³. In addition, we have not attempted to optimize the operation bandwidth, which could be addressed through dispersion engineering, over modest apertures, combination with broadband refractive optics, or use of dispersion to perform wavelength-dependent functions. Further acceleration can be realized via integration of a meta-imager front-end directly with a chip-based photonics back-end such that data readout and transport can be achieved without analog-to-digital converters for ultrafast and low-latency processing.

Our meta-imager may put restrictions on the depth, or number of layers, in the optical front-end which means that it may provide the most benefit in lightweight neural networks such as those found in power-limited or high-speed autonomous applications. Recent advances in machine learning, such as the use of larger kernels for network layer compression⁵⁴ and re-parameterization⁵⁵ could further improve the effectiveness of single, or few layer, meta-imager front-ends. In addition, the capability of meta-optics for multi-functional processing, including wavelength and polarization-based discrimination, can be used to further increase information collection⁴⁴. As a result, this general architecture for meta-imagers can be highly parallel and bridge the gap between the natural world and digital systems, potentially finding use beyond machine vision⁵⁶ in applications such as information security^{57,58} and quantum communications⁵⁹.

### Methods

Optimization of Coma-free Meta-optic. The coma-free meta-optic contains two metasurfaces, whose phase profiles were optimized by the ray tracing technique using commercial optical design software (Zemax OpticSutdio, Zemax LLC). The phase profile of each layer was defined by even order polynomials according to the radial coordinate, ρ, as follows:

$$ϕ ( ρ ) = {\sum }_{n = 1}^{5} {{a}_{n} ( \frac{ρ}{R} )}^{2 n}$$

where R is the radius of the metasurface, and aₙ is the optimized coefficient to minimize the focal spot size of the bilayer metasurfaces system under an incident angle up to 13°. The diameter of the second layer metasurface was 1.5 times that of the first layer to capture all light under high incident angle illumination. The phase profiles were then wrapped within 0 to 2π to be fitted by meta-atoms.

Digital Neural Network Training. The MNIST and Fashion-MNIST database, each containing 60,000 training images with 28×28 pixel format, were used to train the digital convolutional neural network. The channel number for convolution was set to 12, while the kernel size was fixed at 7×7, with the size of the convolutional result remaining the same. The details of neural network architecture are shown in FIG. 5A in the main context. During forward propagation in the neural network, an additional loss function defined by [symbol] =Σₙ₌₁^{N}wₙ was added to ensure equal total intensity of positive and negative kernel values, where wₙ is the weight of each kernel. All the kernel values are normalized to [−1,1], by dividing by a constant, to maximize the diffraction efficiency in the optics. An Adam optimizer was utilized for training the digital parameters with a learning rate of 0.001. The training process is sustained over 50 epochs, during which the performance is optimized by minimizing the negative log-likelihood loss from comparing prediction probabilities and ground truth labels. The algorithm was programmed based on Pytorch 1.10.1 and CUDA 11.0 with a Quadro RTX 5000/PCIe/SSE2 as the graphics cards.

Numerical Simulation. The complex transmission coefficients of the silicon nanopillars were calculated using an open-source rigorous coupled wave analysis (RCWA) solver, Reticolo⁶⁰. A square lattice with a period of 0.45 mm was used for the first metasurface with the working wavelength at 0.87 mm. The second metasurface was assigned a hexagonal lattice with a period of 0.47 mm. During full-wave simulation, the index of silicon and fused silica characterized by ellipsometry was set at 3.74 and 1.45, respectively.

Metasurface Fabrication. EBL-based lithography was used to fabricate all the metasurface layers. First, low-pressure chemical vapor deposition (LPCVD) was utilized to deposit a 630 nm thick silicon device layer on a fused silica substrate. PMMA photoresist was then spin-coated on the silicon layer, followed by thermal evaporation of a 10 nm thick Cr conduction layer. The EBL system then exposed the photoresist, and after removing the Cr layer, the pattern was developed by the MIBK/IPA solution. A 30 nm Al₂O₃ hard mask was deposited via electron beam evaporation, followed by a lift-off process with N-methyl-2-pyrrolidone (NMP) solution. The silicon was then patterned using reactive ion etching, and a 1 mm thick layer of PMMA was spin-coated to encase the nanopillar structures as a protective and index-matching layer.

### Compound Metalens for Wide View-Angle Imaging

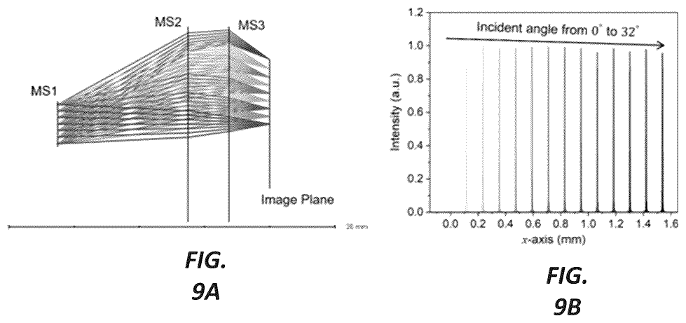

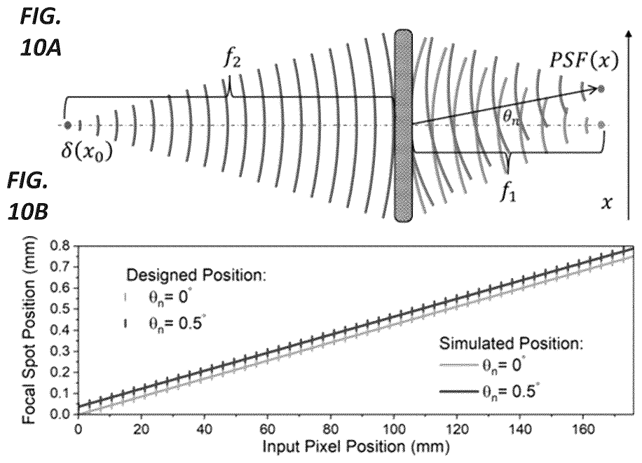

A bilayer wide view-angle metalens was optimized by the commercial software, Zemax. The schematic of the compound metalens is shown in FIG. 8A. The bilayer metalens comprises a wavefront corrector and a light focuser with the phase profiles shown in FIG. 8B. The angular and polarization multiplexing is based on the optimized metalens and all the optical kernel information is encoded in the first corrector layer. In order to verify the wide view-angle functionality, the focal spot profile and the position in terms of the incident plane wave angle were simulated by the angular spectrum propagation method, with the results illustrated in FIG. 8C. With the incident angle varied from 0° to 10°, the focal spot shifts gradually with a constant focal shape. To quantitatively relate the focal spot shifting and incident angle, the focal spot position is fitted by the following equation with the result shown in FIG. 8D:

$$D = {f}_{1} c \cdot tan ( θ ) \qquad ( S 1 )$$

where D is the spot position regarding the radial coordinates. f₁=2500 mm is the focal length, c=1.709 is a constant, and θ is the incident angle. Eq. S1 indicates the relationship between focal spot position and incident angle, which guides design of angular multiplexing, as described below.

### Increased FOV in Cascaded Metalens Design

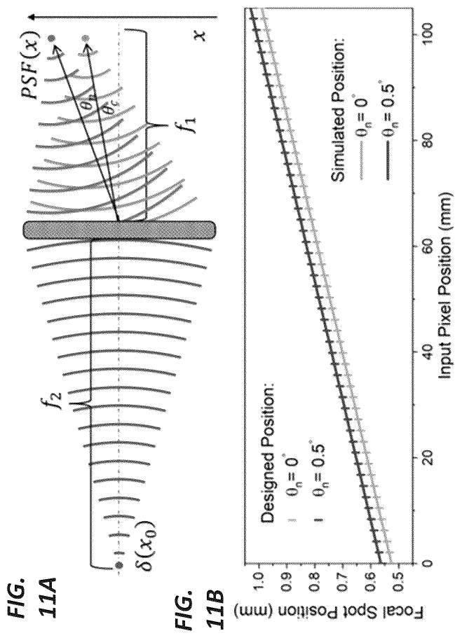

We specifically designed the meta-imager for a 26° field of view (FOV). Beyond this angular range, the PSF's intensity will gradually decrease, leading to aberrated convolutional results. However, wide FOV metalenses have been thoroughly investigated in the past years^{61,62} and thus widening this value is not a fundamental limitation. For instance, a more sophisticated metalens architecture can offer a wider FOV. To verify this, a three-layer metalens system is optimized through Zemax software, which can offer a FOV over 64°, as shown in FIGS. 9A and 9B.

### Point Spread Function for Center Channel

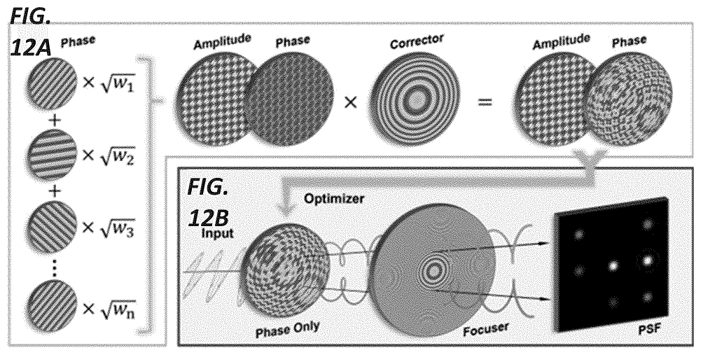

The point spread function (PSF) of the convolutional system can be derived from the f·tan(θ) equation fitted above, which can be used for angular multiplexing. Consider a single channel convolution case as shown in FIG. 10A, the PSF can be expressed by the response of the single pixel excitation from the object. Assume the object is far away from the aperture, the pixel defined by a Dirac function, δ(x₀), can emit a signal approximated by a plane wave with an incident angle, θ₀=atan (x₀/f₂). Here, f₂ is the distance between the object to the aperture. The incident wave, Eᵢₙ, from the pixel, δ(x₀), can be expressed by the following equation:

$${E}_{i n} = exp [ i \frac{2 π}{λ} x \cdot sin ( {θ}_{0} ) ] \qquad ( S 2 )$$

During the angular multiplexing process, the combination of multiple focal spots stands for an optical kernel, while a multiplexed defection angle, θₙ, controls the position of each focal spot. Here, θₙ slightly deviates from the center angle, θ_{c}, which is 0° in the center channel case. By encoding the deflection phase in the coma-free system, the input angular phase can be described as follows:

$${E}_{in}^{′} = exp \{ i \frac{2 π}{λ} x [ sin ( {θ}_{0} ) + sin ( {θ}_{n} ) ] \} \qquad ( S 3 )$$

Considering a small angle of θₙ, Eq. S3 can be simplified as follows:

$${E}_{in}^{′} \approx exp [ i \frac{2 π}{λ} x \cdot sin ( {θ}_{0} + {θ}_{n} ) ] \qquad ( S 4 )$$

Hence, the modulated wave by the encoded angular phase is equivalent to another plane wave with a deflected angle, θ₀+θₙ. According to Eq. S1, the focal spot position of the imaging system can be then described by:

$$D \approx {f}_{1} c \cdot tan ( {θ}_{0} + {θ}_{n} ) \approx {f}_{1} c [ tan ( {θ}_{0} ) + tan ( {θ}_{n} ) ] \qquad ( S 5 )$$

According to 00=atan (x₀/f₂), the focal spot position can be described by:

$$D \approx {f}_{1} c [ \frac{1}{{f}_{2}} {x}_{0} + tan ( {θ}_{n} ) ] \qquad ( S 6 )$$

By defining a focal spot, Θ(x), the PSF in response of δ(x₀) can be expressed by:

$$P S F ( x ) = δ \{ x - {f}_{1} c [ \frac{1}{{f}_{2}} {x}_{0} + tan ( {θ}_{n} ) ] \} ⊗ Θ ( x ) \qquad ( S 7 )$$

For each multiplexed angle, θₙ, a weight wₙ can be encoded into the phase profile. Therefore, for an optical kernel containing N focal spots, the PSF can be described by:

$$P S F ( x ) = {\sum }_{n}^{N} {w}_{n} Θ \{ x - {f}_{1} c [ \frac{1}{{f}_{2}} {x}_{0} + tan ( {θ}_{n} ) ] \} \qquad ( S 8 )$$

Eq. S8 can be readily extended into the 2D situation, which can be used to predict the PSF position and shape as well as dictate the deflected angle, θₙ, which is encoded in the metasurface. A comparison between the designed PSF according to Eq. S8 and the simulated results based on the angular propagation method is shown in FIG. 10B, which indicates an excellent match. The linear relationship between the input pixel and PSF position means an aberration-free convolution process.

### Point Spread Function for Off-Center Channels

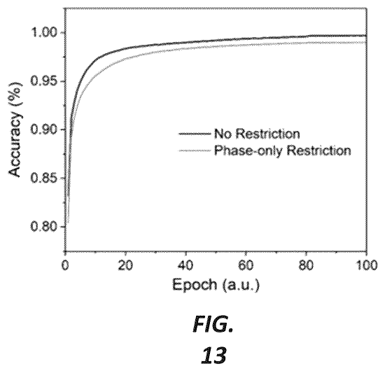

The optical convolution can be extended into a multi-channel case. Here, the PSF of a deflected channel is derived to assist the design process. The schematic of the deflect optical channel is shown in FIG. 11A. Consider an object pixel, δ(x₀), a deflected angle, θ_{c}, and a slight deviation angle, θₙ, which are encoded in the coma-free system to stand for the center and deflected focal spot's positions, the incident plane wave can be expressed as follows:

$${E}_{in}^{′} = exp \{ i \frac{2 π}{λ} x [ sin ( {θ}_{0} ) + sin ( {θ}_{c} ) + sin ( {θ}_{n} ) ] \} \qquad ( S 9 )$$

In order to correlate the deflected angle phase with the focal spot position, a equation is defined and fitted based on the angular terms in Eq. S9:

$$sin ( {a}_{1} {θ}_{0} + {θ}_{c} + {θ}_{n} ) \approx sin ( {θ}_{0} ) + sin ( {θ}_{c} ) + sin ( {θ}_{n} ) \qquad ( S 10 )$$

Therefore, the modulated incident plane wave can now be approximated by:

$${E}_{in}^{′} \approx exp [ i \frac{2 π}{λ} x \cdot sin ( {a}_{1} {θ}_{0} + {θ}_{c} + {θ}_{n} ) ] \qquad ( S 11 )$$

According to Eq. S1 and the small angle approximation of θₙ, the focal spot position of the imaging system can be then described by:

$$D \approx {f}_{1} c \cdot tan ( {a}_{1} {θ}_{0} + {θ}_{c} + {θ}_{n} ) \approx {f}_{1} c [ tan ( {a}_{1} {θ}_{0} + {θ}_{c} ) + tan ( {θ}_{n} ) ] \qquad ( S12 )$$

A linear equation can be further defined to correlate the pixel position, x₀, with the deflected angular information as follows:

$$\frac{{a}_{2}}{{f}_{2}} {x}_{0} + {a}_{3} \approx tan ( {a}_{1} {θ}_{0} + {θ}_{c} ) \qquad ( S13 )$$

Here, the fitting parameters aₙ describe the additional aberrations for a particular angle. However, as demonstrated in the manuscript, such aberrations are small enough to achieve a high-quality convolution process. The PSF can then be analytically described as follows:

$$P S F ( x ) = δ \{ x - {f}_{1} c [ \frac{{a}_{2}}{{f}_{2}} {x}_{0} + {a}_{3} + tan ( {θ}_{n} ) ] \} ⊗ Θ ( x ) \qquad ( S14 )$$

For each multiplexed angle, θₙ, a weight wₙ can be encoded into the phase profile. Therefore, for an optical kernel containing N focal spots, the PSF can be described by:

$$P S F ( x ) = {\sum }_{n}^{N} {w}_{n} Θ \{ x - {f}_{1} c [ \frac{{a}_{2}}{{f}_{2}} {x}_{0} + {a}_{3} + tan ( {θ}_{n} ) ] \} \qquad ( S15 )$$

Eq. S15 can be readily extended into the 2D situation. A comparison between the designed PSF according to Eq. S15 and the simulated results based on the angular propagation method is shown in FIG. 11B, which indicates an excellent match. The linear relationship between the input pixel and PSF position demonstrates that the aberrations induced by deflected angle are minimal.

### Design Process for Meta-Optic

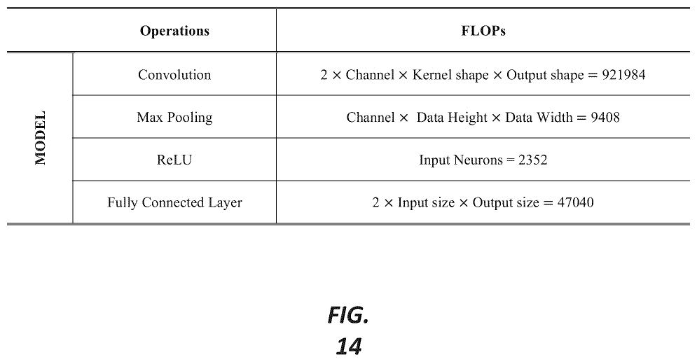

The angular multiplexing method was applied to the first metasurface, as shown in FIG. 12A, for PSF engineering of a single polarization channel. Multiple deflected phase profiles were multiplexed into the first metasurface, with each angular component dictated by the designated position and weighted by the digital kernel. As a result, a complex-amplitude profile, A(x,y), was generated. The complex-amplitude profile will be further multiplied by the phase profile of the corrector in the bilayer metalens system. In order to remove the unnecessary loss in the meta-optic, an optimization algorithm was developed, as shown in the following section, which can convert the complex-amplitude profile into a phase-only metasurface. The updated phase-only profile can correct the wavefront as well as split the incident light into multiple channels as shown in FIG. 12B. Hence, with the focuser as the second metasurface, the optimized meta-optic can generate a series of independent focal spots with the same shape but with various weights and locations, resulting in a custom optical kernel.

### Optimization Algorithm for Phase-Only Approximation

An algorithm was developed based on our previously proposed meta-optic optimization platform, which converts the complex-amplitude profile into a phase-only version. In the angular multiplexing method, the analytical complex-amplitude profile can be expressed as follows:

$$A ( x , y ) = {\sum }_{m}^{M} {\sum }_{n}^{N} \sqrt{{w}_{m n}} exp \{ i \frac{2 π}{λ} [ x sin ( {θ}_{x \vert mn} ) + y sin ( {θ}_{y \vert mn} ) ] \} \qquad ( S16 )$$

where wₘₙ is the kernel weight, θₘₙ is the multiplexed angle in the metasurface, and A is the working wavelength. The optimization process is executed in the angular spectrum space, for which a Fourier transformation is performed on the complex-amplitude profile:

$${A}^{′} ( {k}_{x} , {k}_{y} ) = ℱ \{ A ( x , y ) \} = {\sum }_{m}^{M} {\sum }_{n}^{N} \sqrt{{w}_{m n}} δ ( {k}_{x} - {k}_{x \vert mn} , {k}_{y} - {k}_{y \vert mn} ) \qquad ( S17 )$$

Here δ is the Dirac function, kₓ and k_{y} is the coordinate in Fourier space, k_{x|mn} and k_{y|mn} is the corresponding wave vector of a plane wave with incident angle, θ_{x|mn} and θ_{y|mn}. In order to apply the optimization, a phase term, exp(iϕₘₙ), is defined and multiplied by each Dirac function. In this process, only the phase is controlled, while the weight, wₘₙ, of each kernel element remains unchanged. The intensity profile of the metasurface can be controlled by modifying each phase on the kernel elements, which can be expressed in the real space as follows:

$$E ( x , y ) = {\sum }_{m}^{M} {\sum }_{n}^{N} \sqrt{{w}_{m n}} {ℱ}^{- 1} \{ δ ( - {k}_{x \vert m} , - {k}_{y \vert n} ) exp ( i {ϕ}_{m n} ) \} \qquad ( S18 )$$

The phase-only metasurface requires the intensity profile to be as smooth as possible. Hence, a mean-square-error loss function of optimization is defined by:

$$M S E = {[ \vert E ( x , y ) \vert - mean ( \vert E ( x , y ) \vert ) ]}^{2} \qquad ( S19 )$$

The Adam optimizer is then applied to minimize the loss function, which is further used to update the phase exp(iϕₘₙ).

### Normalization of Kernels for Neural Networks

A value restriction is applied to the kernels during the neural network training process. First, the system becomes lossless since a phase-only metasurface was utilized to form the optical kernels. Hence, the total intensity of focal spots in the positive channel should equal the negative channel, leading to the following equation, Σ_{i,j}kₚₒₛ=Σ_{i,j}|k_{neg}|. Here, i is the channel number, j is the element number in a single kernel, k is the value of kernel element. Second, all the kernels should be normalized to a constant, leading to a total intensity range between [−1,1]. This restriction maximizes the difference between each focal spot making the optical kernel more robust to noise perturbation.

The accuracy curve in terms of the training epochs under phase-only restrictions is shown in FIG. 13. Compared to the no-restriction case, the accuracy will converge to a high, constant value with a difference below 1%. Since the training process is a multiple-dimensional optimization, such restrictions can affect certain local minimums, and the final solutions are infinite. The kernel will then be multiplied by a constant to meet the second restriction. Due to the convolution process, multiplying a constant will not change the probability distribution. Therefore, a robust optical solution replacing digital convolution is possible.

### Floating-Point Operations in Convolutional Neural Network

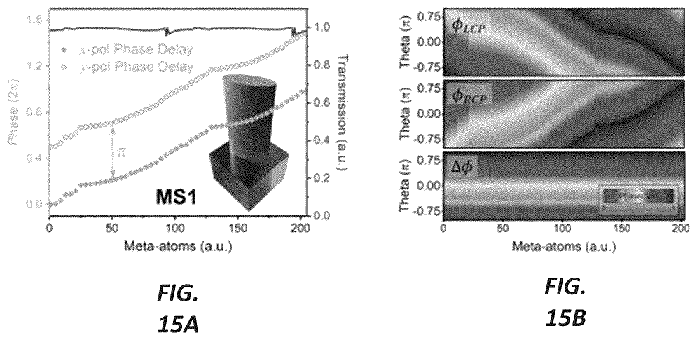

As proof of concept, subtraction is achieved digitally whose FLOPs are not included in FIG. 14 (Table 1). The theoretical FLOPs of subtraction operation are equal to the Max Pooling. However, such process can be replaced by customizing the analog circuits between the neighboring photodetectors^{63,64} so that ultrafast and in-situ subtraction can be achieved.

### Polarization Multiplexed Phase Response of Birefringent Meta-Atoms

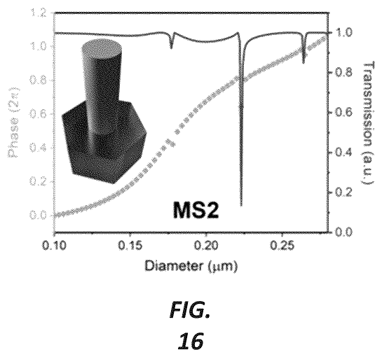

In order to achieve polarization multiplexing, a meta-atom data library was built based on elliptical silicon nanopillars, as shown in FIG. 15A. All the meta-atoms in this data library can perform as a half waveplate, which has a phase response restriction of ϕ_{y}−ϕₓ=π. Here, ϕₓ and ϕ_{y} is the phase response under x and y polarized light excitation with a rotation angle, θ=0. The polarization-sensitive response by the meta-atoms can be analytically described by the Jones Matrix as follows:

$$[ \begin{matrix}{E}_{x} \\ {E}_{y}\end{matrix} ] = [ \begin{matrix}cos ( θ ) & sin ( θ ) \\ - sin ( θ ) & cos ( θ )\end{matrix} ] [ \begin{matrix}{e}^{i {ϕ}_{x}} & 0 \\ 0 & {e}^{i {ϕ}_{x} + π}\end{matrix} ] [ \begin{matrix}cos ( θ ) & - sin ( θ ) \\ sin ( θ ) & cos ( θ )\end{matrix} ] [ \begin{matrix}1 \\ 0\end{matrix} ] \qquad ( S20 )$$

The matrix [1,0]^{T} represents linearly polarized illumination, which includes the LCP and RCP components simultaneously, with equal intensity. Eq. S20 can be simplified as follows:

$$[ \begin{matrix}{E}_{x} \\ {E}_{y}\end{matrix} ] = {e}^{i {ϕ}_{x}} [ \begin{matrix}{cos}^{2} ( θ ) - {sin}^{2} ( θ ) \\ - 2 cos ( θ ) sin ( θ )\end{matrix} ] \qquad ( S21 )$$

In order to separate the circularly polarized components, a quarter waveplate is defined based on the Jones Matrix:

$${M}_{Q W P} = [ \begin{matrix}cos ( π / 4 ) & sin ( π / 4 ) \\ - sin ( π / 4 ) & cos ( π / 4 )\end{matrix} ] [ \begin{matrix}{e}^{i π / 2} & 0 \\ 0 & 1\end{matrix} ] [ \begin{matrix}cos ( π / 4 ) & - sin ( π / 4 ) \\ sin ( π / 4 ) & cos ( π / 4 )\end{matrix} ] \qquad ( S22 )$$

By multiplying Eq. S22 on the left side of Eq. S21, the LCP and RCP electric field can be described as follows:

$$[ \begin{matrix}{E}_{L C P} \\ {E}_{R C P}\end{matrix} ] = {M}_{Q W P} [ \begin{matrix}{E}_{x} \\ {E}_{y}\end{matrix} ] = \frac{1}{2} {e}^{i {ϕ}_{x}} \{ [ \begin{matrix}cos ( 2 θ ) - sin ( 2 θ ) \\ cos ( 2 θ ) - sin ( 2 θ )\end{matrix} ] + i [ \begin{matrix}cos ( 2 θ ) + sin ( 2 θ ) \\ - cos ( 2 θ ) - sin ( 2 θ )\end{matrix} ] \} \qquad ( S23 )$$

By further simplifying Eq. S23, we can get the following:

$$[ \begin{matrix}{E}_{L C P} \\ {E}_{R C P}\end{matrix} ] = \frac{\sqrt{2}}{2} {e}^{i {ϕ}_{x}} [ \begin{matrix}{e}^{i {ϕ}_{θ}} \\ {e}^{- i {ϕ}_{θ}}\end{matrix} ] \qquad ( S24 )$$

where ϕ_{θ} can be defined by the following equation:

$${ϕ}_{θ} = a tan [ \frac{cos ( 2 θ ) + sin ( 2 θ )}{cos ( 2 θ ) - sin ( 2 θ )} ] = [ 2 θ + \frac{π}{4} ] \qquad ( S25 )$$

Combining Eq. S24 and Eq. S25, the output amplitude is unity, while the phase response from different circular polarization states can be described as follows:

$$[ \begin{matrix}{ϕ}_{L C P} \\ {ϕ}_{R C P}\end{matrix} ] = [ \begin{matrix}{ϕ}_{x} + 2 θ + π / 4 \\ {ϕ}_{x} - 2 θ - π / 4\end{matrix} ] \qquad ( S26 )$$

Hence, the phase delay for orthogonal circular polarization light can be independently controlled by controlling the width, length, and rotation angle of the meta-atoms. The phase response calculated by full-wave simulation based on the built data library is shown in FIG. 15B, which matches the result in Eq. S26 and indicates an independent and complete 2π phase control for LCP and RCP light.

### Phase Response of Circular Nanopillars

FIG. 16 illustrates Phase Delay of the Circular Silicon Nanopillars as a Function of the Diameter.

### Phase Profile of Meta-Optic

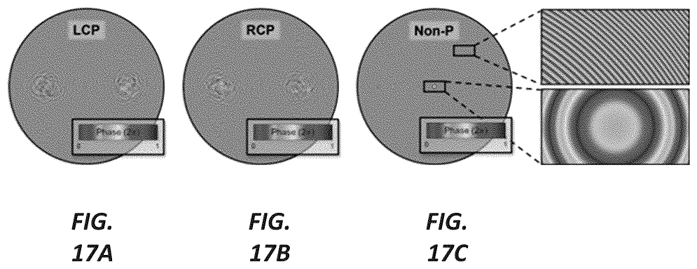

FIGS. 17A-17C illustrate the Phase Profile of a Designed Meta-optic.

### REFERENCES

1. Simonyan, K. & Zisserman, A. Very deep convolutional networks for large-scale image recognition. 3rd International Conference on Learning Representations, ICLR 2015-Conference Track Proceedings 1-14 (2015).
2. Wang, G. et al. Interactive Medical Image Segmentation Using Deep Learning with Image-Specific Fine Tuning. IEEE Trans Med Imaging 37, 1562-1573 (2018).
3. Furui, S., Deng, L., Gales, M., Ney, H. & Tokuda, K. Fundamental technologies in modern speech recognition. IEEE Signal Process Mag 29, 16-17 (2012).
4. Sak, H., Senior, A., Rao, K. & Beaufays, F. Fast and accurate recurrent neural network acoustic models for speech recognition. Proceedings of the Annual Conference of the International Speech Communication Association, INTERSPEECH 2015-Janua, 1468-1472 (2015).
5. He, K., Zhang, X., Ren, S. & Sun, J. Deep residual learning for image recognition. Proceedings of the IEEE Computer Society Conference on Computer Vision and Pattern Recognition 2016-Decem, 770-778(2016).
6. Lecun, Y., Bengio, Y. & Hinton, G. Deep learning. Nature 521, 436-444 (2015).
7. Mennel, L. et al. Ultrafast machine vision with 2D material neural network image sensors. Nature 579, 62-66 (2020).
8. Liu, L. et al. Computing Systems for Autonomous Driving: State of the Art and Challenges. IEEE Internet Things J 8, 6469-6486 (2021).
9. Shi, W. et al. LOEN: Lensless opto-electronic neural network empowered machine vision. Light Sci Appl 11, (2022).
10. Hamerly, R., Bernstein, L., Sludds, A., Soljačić, M. & Englund, D. Large-Scale Optical Neural Networks Based on Photoelectric Multiplication. Phys Rev X 9, 1-12 (2019).
11. Wetzstein, G. et al. Inference in artificial intelligence with deep optics and photonics. Nature 588, 39-47 (2020).
12. Shastri, B. J. et al. Photonics for artificial intelligence and neuromorphic computing. Nat Photonics 15, 102-114 (2021).
13. Xue, W. & Miller, O. D. High-NA optical edge detection via optimized multilayer films. Journal of Optics (United Kingdom) 23, (2021).
14. Wang, T. et al. An optical neural network using less than 1 photon per multiplication. Nat Commun 13, 123 (2022).
15. Wang, T. et al. Image sensing with multilayer nonlinear optical neural networks. Nat Photonics 17, 8-17 (2023).
16. Badloe, T., Lee, S. & Rho, J. Computation at the speed of light: metamaterials for all-optical calculations and neural networks. Advanced Photonics vol. 4 Preprint at https://doi.org/10.1117/1.AP.4.6.064002 (2022).
17. Vanderlugt, A. Optical signal processing. Wiley (1993).
18. Chang, J., Sitzmann, V., Dun, X., Heidrich, W. & Wetzstein, G. Hybrid optical-electronic convolutional neural networks with optimized diffractive optics for image classification. Sci Rep 8, 1-10 (2018).
19. Colburn, S., Chu, Y., Shilzerman, E. & Majumdar, A. Optical frontend for a convolutional neural network. Appl Opt 58, 3179 (2019).
20. Zhou, T. et al. Large-scale neuromorphic optoelectronic computing with a reconfigurable diffractive processing unit. Nat Photonics 15, 367-373 (2021).
21. Chen, Y. H., Krishna, T., Emer, J. S. & Sze, V. Eyeriss: An Energy-Efficient Reconfigurable Accelerator for Deep Convolutional Neural Networks. IEEE J Solid-State Circuits 52, 127-138 (2017).
22. Neshatpour, K., Homayoun, H. & Sasan, A. ICNN: The iterative convolutional neural network. ACM Transactions on Embedded Computing Systems 18, (2019).
23. Xu, X. et al. 11 TOPS photonic convolutional accelerator for optical neural networks. Nature 589, 44-51 (2021).
24. Feldmann, J. et al. Parallel convolutional processing using an integrated photonic tensor core. Nature 589, 52-58 (2021).
25. Wu, C. et al. Programmable phase-change metasurfaces on waveguides for multimode photonic convolutional neural network. Nat Commun 12, 1-8 (2021).
26. Zhang, H. et al. An optical neural chip for implementing complex-valued neural network. Nat Commun 12, 1-11 (2021).
27. Ashtiani, F., Geers, A. J. & Aflatouni, F. An on-chip photonic deep neural network for image classification. Nature 606, 501-506 (2022).
28. Fu, T. et al. Photonic machine learning with on-chip diffractive optics. Nat Commun 14, 1-10 (2023).
29. Lin, X. et al. All-optical machine learning using diffractive deep neural networks. Science (1979) 361, 1004-1008 (2018).
30. Qian, C. et al. Performing optical logic operations by a diffractive neural network. Light Sci Appl 9, (2020).
31. Luo, X. et al. Metasurface-enabled on-chip multiplexed diffractive neural networks in the visible. Light Sci Appl 11, (2022).
32. Kwon, H., Arbabi, E., Kamali, S. M., Faraji-Dana, M. S. & Faraon, A. Single-shot quantitative phase gradient microscopy using a system of multifunctional metasurfaces. Nat Photonics 14, 109-114 (2020).
33. Xiong, B. et al. Breaking the limitation of polarization multiplexing in optical metasurfaces with engineered noise. Science 379, 294-299 (2023).
34. Khorasaninejad, M. et al. Metalenses at visible wavelengths: Diffraction-limited focusing and subwavelength resolution imaging. Science (1979) 352, 1190-1194 (2016).
35. Kim, J. et al. Scalable manufacturing of high-index atomic layer-polymer hybrid metasurfaces for metaphotonics in the visible. Nat Mater 22, 474-481 (2023).
36. Levanon, N. et al. Angular Transmission Response of In-Plane Symmetry-Breaking Quasi-BIC All-Dielectric Metasurfaces. ACS Photonics 9, 3642-3648 (2022).
37. Nolen, J. R., Overvig, A. C., Cotrufo, M. & Alu, A. Arbitrarily polarized and unidirectional emission from thermal metasurfaces. arXiv (2023).
38. Guo, C., Xiao, M., Minkov, M., Shi, Y. & Fan, S. Photonic crystal slab Laplace operator for image differentiation. Optica 5, 251 (2018).
39. Cordaro, A. et al. High-Index Dielectric Metasurfaces Performing Mathematical Operations. Nano Lett 19, 8418-8423 (2019).
40. Zhou, Y., Zheng, H., Kravchenko, I. I. & Valentine, J. Flat optics for image differentiation. Nat Photonics 14, 316-323 (2020).
41. Fu, W. et al. Ultracompact meta-imagers for arbitrary all-optical convolution. Light Sci Appl 11, (2022).
42. Wang, H., Guo, C., Zhao, Z. & Fan, S. Compact Incoherent Image Differentiation with Nanophotonic Structures. ACS Photonics 7, 338-343 (2020).
43. Zhang, X., Bai, B., Sun, H. B., Jin, G. & Valentine, J. Incoherent Optoelectronic Differentiation Based on Optimized Multilayer Films. Laser Photon Rev 16, 1-8 (2022).
44. Zheng, H. et al. Meta-optic accelerators for object classifiers. Sci Adv 8, 1-9 (2022).
45. Bernstein, L. et al. Single-Shot Optical Neural Network. Sci Adv 9, 1-10 (2023).
46. Shen, Z. et al. Monocular metasurface camera for passive single-shot 4D imaging. Nat Commun 14, 1-8 (2023).
47. LeCun, Y., Bottou, L., Bengio, Y. & Haffner, P. Gradient-based learning applied to document recognition. Proceedings of the IEEE 86, 2278-2323 (1998).
48. Zheng, H. et al. Compound Meta-Optics for Complete and Loss-Less Field Control. ACS Nano 16, 15100-15107 (2022).
49. Liu, S. et al. More ConvNets in the 2020s: Scaling up Kernels Beyond 51×51 using Sparsity. arXiv (2022).
50. Barron, J. T. A general and adaptive robust loss function. Proceedings of the IEEE Computer Society Conference on Computer Vision and Pattern Recognition 2019-June 4326-4334 (2019).
51. Dosovitskiy, A. et al. An Image is Worth 16×16 Words: Transformers for Image Recognition at Scale. arXiv (2020).
52. Stillmaker, A. & Baas, B. Scaling equations for the accurate prediction of CMOS device performance from 180 nm to 7 nm. Integration 58, 74-81 (2017).
53. McClung, A., Samudrala, S., Torfeh, M., Mansouree, M. & Arbabi, A. Snapshot spectral imaging with parallel metasystems. Sci Adv 6, 1-9 (2020).
54. Ding, X., Zhang, X., Han, J. & Ding, G. Scaling Up Your Kernels to 31×31: Revisiting Large Kernel Design in CNNs. in Proceedings of the IEEE Computer Society Conference on Computer Vision and Pattern Recognition vols 2022-June 11953-11965 (IEEE Computer Society, 2022).
55. Ding, X. et al. RepVgg: Making VGG-style ConvNets Great Again. in Proceedings of the IEEE Computer Society Conference on Computer Vision and Pattern Recognition 13728-13737 (IEEE Computer Society, 2021). doi: 10.1109/CVPR46437.2021.01352.
56. Li, L. et al. Intelligent metasurface imager and recognizer. Light Sci Appl 8, (2019).
57. Zhao, R. et al. Multichannel vectorial holographic display and encryption. Light Sci Appl 7, (2018).
58. Kim, I. et al. Pixelated bifunctional metasurface-driven dynamic vectorial holographic color prints for photonic security platform. Nat Commun 12, 1-9 (2021).
59. Li, L. et al. Metalens-array-based high-dimensional and multiphoton quantum source. Science (1979) 368, 1487-1490 (2020).
60. Hugonin, A. J. P. & Lalanne, P. RETICOLO CODE 1D for the diffraction by stacks of lamellar 1D gratings. arXiv (2012).
61. Shalaginov, M. Y. et al. Single-Element Diffraction-Limited Fisheye Metalens. Nano Lett 20, 7429-7437 (2020).
62. Li, S. & Hsu, C. W. Thickness bound for nonlocal wide-field-of-view metalenses. Light Sci Appl 11, (2022).
63. Sotner, R., Herencsar, N., Kledrowetz, V., Kartci, A. & Jerabek, J. New low-voltage CMOS differential difference amplifier (DDA) and an application example, in Midwest Symposium on Circuits and Systems vols 2018-August 133-136 (Institute of Electrical and Electronics Engineers Inc., 2019).
64. Mennel, L. et al. Ultrafast machine vision with 2D material neural network image sensors. Nature 579, 62-66 (2020).
65. Zheng, H. et al. Compound Meta-Optics for Complete and Loss-Less Field Control. ACS Nano 16, 15100-15107 (2022).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A machine vision system comprising:
a meta-imager comprising:
a meta-optic, and
a polarization-sensitive photodetector;
at least one processor operably coupled to the polarization-sensitive photodetector; and
at least one memory operably coupled to the at least one processor, the at least one memory having computer-executable instructions stored thereon that, when executed by the at least one processor, cause the at least one processor to:
receive, from the polarization-sensitive photodetector, a plurality of feature maps;
input, into a trained artificial neural network, the plurality of feature maps; and
process, using the trained artificial neural network, the plurality of feature maps to recognize an object.

2. The machine vision system of claim 1, wherein the meta-optic is configured to optically implement at least one convolutional layer for the machine vision system.

3. The machine vision system of claim 1, wherein the meta-optic comprises a first metasurface configured for angular multiplexing and polarization multiplexing.

4. The machine vision system of claim 1, wherein the meta-optic comprises a second metasurface configured for configured for focusing.

5. The machine vision system of claim 1, wherein a point spread function of the meta-optic comprises a plurality of focal spots, wherein the meta-optic is configured to encode each of the plurality of focal spots with a respective kernel weight.

6. The machine vision system of claim 5, wherein the plurality of focal spots comprise an N×N focal spot array.

7. The machine vision system of claim 5, wherein a positively valued kernel weight is achieved by encoding a first focal spot with a first polarization state, and a negatively valued kernel weight is achieved by encoding a second focal spot with a second polarization state, wherein the first and second polarization states are orthogonal polarization states.

8. The machine vision system of claim 7, wherein the first polarization state is one of right-hand-circular polarization (RCP) or left-hand-circular polarization (LCP), and the second polarization state is the other of RCP or LCP.

9. The machine vision system of claim 7, wherein the first polarization state is one of vertical linear polarization or horizontal linear polarization, and the second polarization state is the other of vertical linear polarization or horizontal linear polarization.

10. The machine vision system of claim 1, wherein the meta-imager further comprises a single aperture through which incoherent light enters the meta-imager.

11. The machine vision system of claim 1, wherein processing, using the trained artificial neural network, the plurality of feature maps to recognize the object comprises detecting the object.

12. The machine vision system of claim 1, wherein processing, using the trained artificial neural network, the plurality of feature maps to recognize the object comprises classifying the object.

13. The machine vision system of claim 1, wherein the trained artificial neural network comprises at least one of a pooling layer, a flattening layer, an activation layer, and a fully-connected layer.

14. A method comprising:
imaging an object with a meta-imager configured for multi-channel convolution, wherein the meta-imager outputs a plurality of feature maps;
inputting, into a trained artificial neural network, the plurality of feature maps; and
processing, using the trained artificial neural network, the plurality of feature maps to recognize the object.

15. The method of claim 14, wherein imaging the object comprises capturing incoherent light reflected from or emitted by the object.

16. The method of claim 14, wherein the meta-imager is configured to optically implement convolutional operations.

17. The method of claim 14, wherein processing, using the trained artificial neural network, the plurality of feature maps to recognize the object comprises detecting the object.

18. The method of claim 14, wherein processing, using the trained artificial neural network, the plurality of feature maps to recognize the object comprises classifying the object.

19. The method of claim 14, wherein the meta-imager comprises a meta-optic, wherein a point spread function of the meta-optic comprises a plurality of focal spots, wherein the meta-optic is configured to encode each of the plurality of focal spots with a respective kernel weight, wherein a positively valued kernel weight is achieved by encoding a first focal spot with a first polarization state, and a negatively valued kernel weight is achieved by encoding a second focal spot with a second polarization state, and wherein the first and second polarization states are orthogonal polarization states.

20. The method of claim 14, wherein the trained artificial neural network comprises at least one of a pooling layer, a flattening layer, an activation layer, and a fully-connected layer.
